(19) United States
(12) Patent Application Publication
(10) Pub. No.: US 2021/0149882 A1
(43) Pub. Date: May 20, 2021

(54) FIELD UPDATE METHOD AND APPARATUS, AND ELECTRONIC DEVICE

(71) Applicant: Advanced New Technologies Co., Ltd., George Town (KY)

(72) Inventors: Benquan Yu, Hangzhou (CN); Haizhen Zhuo, Hangzhou (CN); Zhonghao Lu, Hangzhou (CN); Faqiang Wang, Hangzhou (CN)

(73) Assignee: Advanced New Technologies Co., Ltd., George Town (KY)

(21) Appl. No.: 17/159,054

(22) Filed: Jan. 26, 2021

Related U.S. Application Data
(63) Continuation of application No. PCT/CN2019/114975, filed on Nov. 1, 2019.

(30) Foreign Application Priority Data
Dec. 20, 2018 (CN) 201811564469.2

(51) Int. Cl. G06F 16/23; G06F 16/27

(52) U.S. Cl. CPC G06F 16/2379; G06F 16/27

(57) ABSTRACT

One or more embodiments of the present specification provide field update methods and apparatuses, and devices. A computer-implemented method can include the following: obtaining, by a blockchain node in a blockchain network, a field update request for a smart contract, where the field update request is used to implement a field update on data in a data set included in the smart contract; adjusting, by the blockchain node based on the field update request and as adjusted metadata, metadata included in the smart contract; and parsing, using code in the smart contract, the adjusted metadata to update a field associated with the field update request.

### CROSS-REFERENCE TO RELATED APPLICATIONS

This application is a continuation of PCT Application No. PCT/CN2019/114975, filed on Nov. 1, 2019, which claims priority to Chinese Patent Application No. 201811564469.2, filed on Dec. 20, 2018, and each application is hereby incorporated by reference in its entirety.

### TECHNICAL FIELD

One or more embodiments of the present specification relate to the field of blockchain technologies, and in particular, to field update methods and apparatuses, and electronic devices.

### BACKGROUND

A blockchain technology (also referred to as a distributed ledger technology) is a decentralized distributed database technology characterized by decentralization, openness, transparency, tamper resistance, and trustworthiness, and can be applied to many application scenarios with high demands on data reliability.

### SUMMARY

In view of this, one or more embodiments of the present specification provide field update methods and apparatuses, and electronic devices.

To achieve the previous objective, one or more embodiments of the present specification provide the following technical solutions:

According to a first aspect of one or more embodiments of the present specification, a field update method is proposed, including: obtaining, by a blockchain node in a blockchain network, a field update request for a smart contract, where the field update request is used to implement a field update on data in a data set included in the smart contract; and adjusting, by the blockchain node based on the field update request, metadata included in the smart contract, such that a field update is achieved on the data in the data set after parsing the adjusted metadata by using code included in the smart contract.

According to a second aspect of one or more embodiments of the present specification, a field update apparatus is proposed, including: a first acquisition unit, configured to enable a blockchain node in a blockchain network to obtain a field update request for a smart contract, where the field update request is used to implement a field update on data in a data set included in the smart contract; and an adjustment unit, configured to enable the blockchain node to adjust, based on the field update request, metadata included in the smart contract, such that a field update is achieved on the data in the data set after parsing the adjusted metadata by using code included in the smart contract.

According to a third aspect of one or more embodiments of the present specification, an electronic device is proposed, including: a processor; and a memory, configured to store an instruction executable by the processor, where the processor is configured to implement the field update method according to any one of the previous embodiments.

### BRIEF DESCRIPTION OF DRAWINGS

FIG. 1 is a flowchart illustrating a field update method, according to some example embodiments;

FIG. 2 is a schematic diagram illustrating a data structure of a smart contract, according to some example embodiments;

FIG. 3 is a schematic diagram illustrating addition of a new field, according to some example embodiments;

FIG. 4 is a schematic diagram illustrating deletion of an existing field, according to some example embodiments;

FIG. 5 is a schematic diagram illustrating modification of an existing field, according to some example embodiments;

FIG. 6 is a schematic diagram illustrating querying a blockchain balance, according to some example embodiments;

FIG. 7 is a schematic structural diagram illustrating a device, according to some example embodiments; and

FIG. 8 is a block diagram illustrating a field update apparatus, according to some example embodiments.

### DESCRIPTION OF EMBODIMENTS

Example embodiments are described in detail here, and examples of the example embodiments are presented in the accompanying drawings. When the following description relates to the accompanying drawings, unless specified otherwise, same numbers in different accompanying drawings represent same or similar elements. Implementations described in the example embodiments below do not represent all implementations consistent with one or more embodiments of the present specification. On the contrary, the implementations are only examples of apparatuses and methods that are described in the appended claims in detail and consistent with some aspects of one or more embodiments of the present specification.

Notably, steps of a corresponding method in other embodiments are not necessarily implemented in a sequence shown and described in the present specification. In some other embodiments, the method can include more or less steps than steps described in the present specification. In addition, a single step described in the present specification may be divided into multiple steps for description in other embodiments; and multiple steps described in the present specification may be combined into a single step for description in other embodiments.

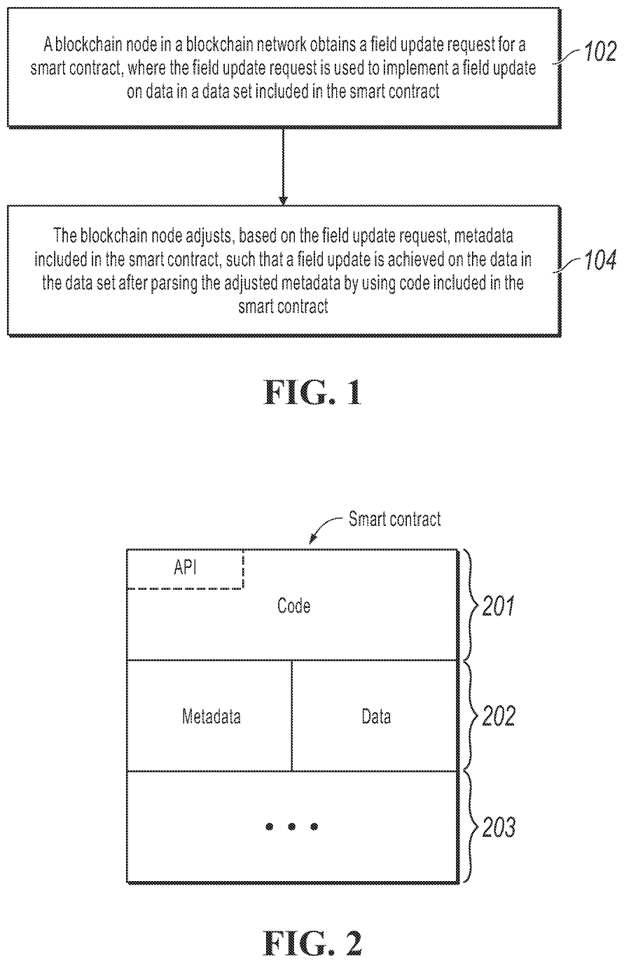

FIG. 1 is a flowchart illustrating a field update method, according to some example embodiments. As shown in FIG. 1, the method can include the following steps.

Step 102: A blockchain node in a blockchain network obtains a field update request for a smart contract, where the field update request is used to implement a field update on data in a data set included in the smart contract.

In some embodiments, a field update request can be included in a transaction created in a blockchain network. By specifying a contract address and port information, etc. of a smart contract that needs to be invoked in the transaction, the field update request is identified as “targeted for” the above-mentioned smart contract, such that a field update is achieved on a data set included in the smart contract.

In some embodiments, a transaction (transaction) described in the present specification refers to a piece of data that is created by using a client device corresponding to a blockchain node and that needs to be finally published to a distributed database of a blockchain network. A transaction in a blockchain network can be a transaction in a narrow sense and a transaction in a broad sense. A transaction in the narrow sense refers to a value transfer published to a blockchain network. For example, in a conventional bitcoin blockchain network, a transaction can be a transfer initiated in the blockchain network. A transaction in the broad sense refers to a piece of service data that is published to a blockchain network and that has a service intention. For example, an operator can establish a consortium blockchain based on actual service needs, and deploy some other types of online services (for example, a house rental service, a vehicle dispatch service, an insurance claims service, a credit service, and a medical service) that are unrelated to a value transfer in the consortium blockchain. In such a consortium blockchain, a transaction can be a service message or a service request that is published in the consortium blockchain and that has a service intention.

In some embodiments, the field update request in the present specification can be included in a transaction in the broad sense described above. For example, the data set included in the smart contract records account data of a user in several aspects such as an account ID, a telephone number, an identity card number, and a blockchain balance of each type of blockchain asset. The account data is separately recorded in corresponding fields, and the transaction is used to add a new field, or can be used to update one or more existing fields, for example, modify a field attribute or delete a field.

In some embodiments, the smart contract can include several structures, such as a code structure for recording code, a storage structure for recording data sets and metadata, etc. In other embodiments, code, data sets, and metadata can be recorded in other structures in the smart contract. Implementations are not limited in the present specification.

In some embodiments, an initiator of the field update request can include a blockchain member in the blockchain network. A role of the blockchain member can be fulfilled by a person, an enterprise organization, or a platform, etc. A corresponding operation, for example, initiation of the previous field update request, can be implemented in the blockchain network based on the role of the “blockchain member”.

In some embodiments, the initiator of the field update request can include another smart contract that is different from the smart contract. For example, a contract operation based on the other smart contract needs a field update on the data in the data set of the smart contract during execution. Therefore, the contract operation based on the other smart contract can initiate the previous field update request to implement a corresponding field update operation. The other smart contract can be invoked by a blockchain member or yet another smart contract. Implementations are not limited in the present specification.

Step 104: The blockchain node adjusts, based on the field update request, metadata included in the smart contract, such that a field update is achieved on the data in the data set after parsing the adjusted metadata by using code included in the smart contract.

In some embodiments, because metadata for the data set has been added to the smart contract, updating the data set directly will not be necessary when a field update is needed for the data in the data set. Instead, only the metadata needs to be updated so the previous field update can be implemented on the data set after the code is executed to parse the metadata, thereby greatly simplifying a field update process and improving field update efficiency.

In some embodiments, the blockchain node can read input parameters included in the field update request. The input parameters include a target object, where the adjusted metadata is used to determine a field corresponding to the target object from the data set so as to delete the field corresponding to the target object. For example, a data set in a smart contract is used to record a status of a user's ownership over a blockchain asset, and the status of ownership can include information in several aspects, for example, can be recorded based on the following fields: an account ID, a telephone number, an identity card number, a balance of a type A blockchain asset, a balance of a type B blockchain asset, a total asset amount—RMB (total asset amount counted in RMB). Assuming that the status of ownership no longer needs to include the “total asset amount—RMB” field, the previous field update request can be initiated with the previous target object including a name or an identifier, etc. of a field to be deleted, so as to update the metadata included in the smart contract. As such, information about the “total asset amount—RMB” field can be removed from a data set description in the metadata. Correspondingly, after the code included in the smart contract is run to parse the metadata, the “total asset amount—RMB” field can be deleted and data corresponding to the field can be invalidated.

In some embodiments, the blockchain node can read input parameters included in the field update request. The input parameters include a target object and a field attribute, where the adjusted metadata is used to determine a field corresponding to the target object from the data set so as to update an attribute of the determined field to the field attribute. For example, a data set in a smart contract is used to record a status of a user's ownership over a blockchain asset, and the status of ownership can include information in several aspects, for example, can be recorded based on the following fields: an account ID, a telephone number, an identity card number, a balance of a type A blockchain asset, a balance of a type B blockchain asset, a total asset amount—RMB. Assuming that the “total asset amount—RMB” field needs to be modified to a “total asset amount—USD (total asset amount counted in USD)” field, the previous field update request can be initiated with the previous target object including a name or an identifier, etc. of a field to be deleted, so as to update the metadata included in the smart contract. As such, the “total asset amount—RMB” field can be modified to the “total asset amount—USD” field in a data set description in the metadata. Certainly, a method for calculating a value of the field further needs to be updated synchronously. For example, the original “total asset amount—RMB” field needs to be calculated based on an exchange ratio of each type of blockchain asset to RMB. After the modification, the field needs to be calculated based on an exchange ratio of each type of blockchain asset to USD. The calculation method can be recorded in an attribute of the previous field, and relevant configuration can be completed during the above-mentioned metadata update operation. As such, after the code included in the smart contract is run to parse the metadata, the modification of the “total asset amount—RMB” field to the “total asset amount—USD” field can be completed.

In some embodiments, the blockchain node can read input parameters included in the field update request. The input parameters include a field attribute, where the adjusted metadata is used to add a field to the data set, and set an attribute of the added field to the field attribute. For example, a data set in a smart contract is used to record a status of a user's ownership over a blockchain asset, and the status of ownership can include information in several aspects, for example, can be recorded based on the following fields: an account ID, a telephone number, an identity card number, a balance of a type A blockchain asset, a balance of a type B blockchain asset, a total asset amount—RMB. Assuming that a “total asset amount—USD” field needs to be added, the previous field update request can be initiated, where a field attribute included in the field update request can include a field name “total asset amount—USD” and a method for calculating a value of the field (related to an exchange ratio of each type of blockchain asset to USD and so on), etc., and the metadata included in the smart contract can be updated based on the information included in the field attribute. As such, content of the “total asset amount—USD” field can be added to a data set description in the metadata. Correspondingly, after the code included in the smart contract is run to parse the metadata, the addition of the “total asset amount—RMB” field can be completed.

In some embodiments, the data set includes data of at least one user; and the blockchain node can read input parameters included in the field update request. The input parameters include information about a target user, where the adjusted metadata is used to determine data corresponding to the target user from the data set so as to update a field of the data corresponding to the target user. In other words, the field update request can be used for all users or only some users in the data set. Implementations are not limited in the present specification. For example, when the input parameters include information about one or more users, the one or more users are target users, and a field update can be implemented on data corresponding to the target users, for example, a “balance of a type X blockchain asset” field can be added for some users that own the type X blockchain asset, where a value of the field is an amount of the type X blockchain asset owned by a corresponding user. For another example, when the input parameters include all users or unspecific users, the target user can be all users, for example, a “balance of a type X blockchain asset” field can be added for all users, where a value of the field is an amount of the type X blockchain asset owned by a corresponding user. Similar to the description in the previous embodiments, when a field needs to be added, a field attribute can be included in the field update request, so that the related field can be added for a target user after the metadata is adjusted, and an attribute of the added field can be set to the field attribute. Certainly, in addition to adding a field, an existing field can alternatively be modified or deleted. For example, when an existing field needs to be modified, the field update request can include a target object and a field attribute. For another example, when an existing field needs to be deleted, the field update request can include a target object. Details are omitted here for simplicity.

In some embodiments, the blockchain node parses the adjusted metadata by running the code included in the smart contract so as to implement a field update on global data of the data set based on a parsing result. For example, when a field update request needs to add a new field to data of all users, or modify or delete an existing field for the data of all the users, a field update can be implemented on global data (namely, the data of all the users), so that the previous new field is added to the data of all the users, or the previous existing field is modified or deleted in the data of all the users. After completing the adjustment on the metadata, the blockchain node can run the code to parse the adjusted metadata immediately or until an idle time period, to implement the field update on the global data.

In some embodiments, the blockchain node obtains a data read and write request for the smart contract, where the data read and write request is used to implement a data read and write operation on a target object in the data set; and the blockchain node parses the adjusted metadata by running the code included in the smart contract, where a parsing result is used to determine target data corresponding to the target object in the data set and implement a field update on the target data so as to implement the data read and write operation on the target data after the field update. In other words, after adjusting the metadata, the blockchain node does not need to actively implement a field update on the data in the data set, but can implement the field update on one or more pieces of data in the data set only when a data read and write need is generated for the one or more pieces of data (for example, a corresponding data read and write request is received). For example, the blockchain node can add a related field and its value, delete a related field and its value, or modify a related field and its value. Therefore, when only a few related fields are involved, resource consumption of the blockchain node can be greatly reduced.

In some embodiments, after the metadata included in the smart contract and the data in the data set are updated based on the field update request, the data in the smart contract has actually been modified. The blockchain node can publish the modified smart contract to the blockchain network and broadcast the modified smart contract to other blockchain nodes in the blockchain network, thereby updating the smart contract throughout the blockchain network.

FIG. 2 is a schematic structural diagram illustrating a smart contract, according to some example embodiments. As shown in FIG. 2, in the embodiments of the present specification, a structural improvement is carried out for the smart contract in the blockchain network to implement a data read and write solution based on the present specification. The smart contract can include a structure 201. For example, the structure 201 can be referred to as a code structure, and is used to record contract code (referred to as code for short) of the smart contract. The smart contract can include a structure 202. For example, the structure 202 can be referred to as a storage structure, and is used to record contract data (referred to as data for short) in the smart contract and metadata corresponding to the contract data. The metadata is used to describe the corresponding contract data. The smart contract can further include other structures 203, such as a balance structure and a nonce structure in related technologies. Implementations are not limited in the present specification. The smart contract can externally provide an application-programming interface (API) for contract code in the structure 201 so as to invoke the contract code.

A field update solution of the present specification can be implemented based on the smart contract in the structure shown in FIG. 2. The following describes in detail the field update solution based on the present specification by using a management operation for a blockchain balance as example. Assuming that smart contract S is recorded in a distributed ledger of a blockchain network, data (or referred to as a data set) included in smart contract S is described in the following Table 1, including personal information (such as an account ID, an age, an address, etc.) of a user owning each account, and a status of each account's ownership over each type of blockchain asset.

TABLE 1

| Account | | | | Balance- | Balance- | Total- |
|---|---|---|---|---|---|---|
| ID | Age | Tel | . . . | Type A | Type B | RMB |
| 0001 | 26 | 139 . . . | . . . | 2000 | 1500 | 5000 |
| 0002 | 25 | 186 . . . | . . . | 1000 | 6000 | 13000 |
| 0003 | 32 | 166 . . . | . . . | 20000 | 2100 | 24200 |
| . . . | . . . | . . . | . . . | . . . | . . . | . . . |

In some embodiments, a role “anchor point” exists in a blockchain network. The anchor point is used to anchor mappings between blockchain assets on the blockchain network and off-chain assets outside the blockchain network. As such, an off-chain asset can be converted into an equivalent blockchain asset by using the anchor point, and a blockchain asset can also be converted into an equivalent off-chain asset by using the anchor point, thereby implementing one-to-one mappings between the blockchain assets and the off-chain assets. Assuming that a certain anchor point publishes a new type X blockchain asset to a blockchain network, and the type X blockchain asset does not originally exist in the data described in Table 1. Therefore, a corresponding field needs to be added to the data included in smart contract S so as to accommodate subsequent cases that each user may own the type X blockchain asset.

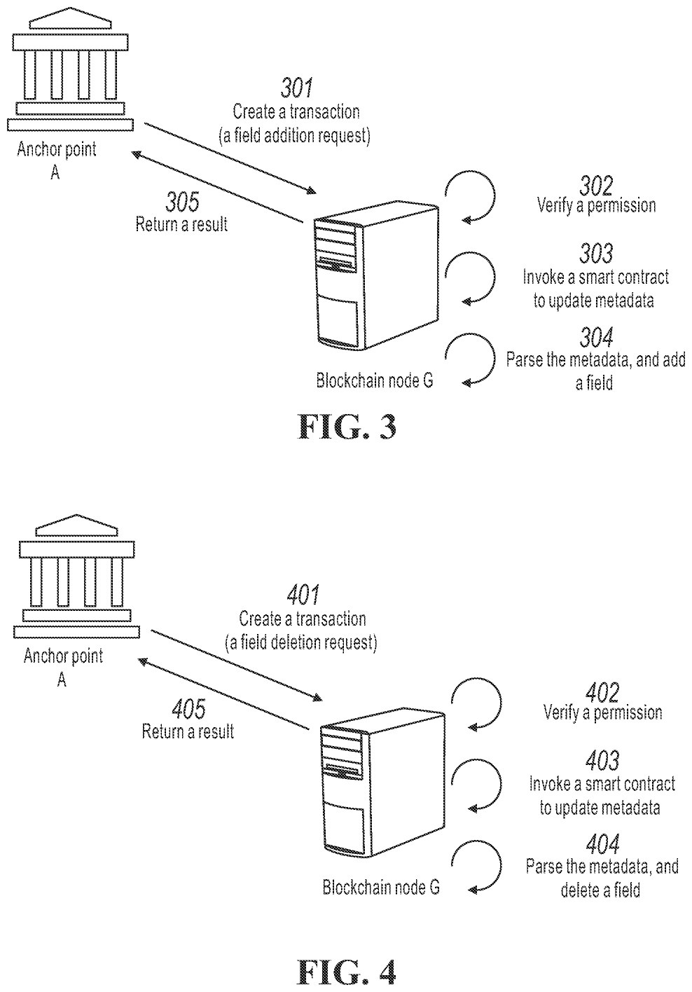

FIG. 3 is a schematic diagram illustrating addition of a new field, according to some example embodiments. As shown in FIG. 3, a process of adding a new field can include the following steps:

Step 301: Create a transaction.

In some embodiments, assuming that anchor point A needs to publish a type X blockchain asset to a blockchain network, anchor point A needs to add a corresponding field to the data included in the above-mentioned smart contract S to record a status of a user's ownership over the type X blockchain asset. Therefore, anchor point A can create a field addition transaction (which is equivalent to a field addition request) and publish the transaction to the blockchain network. Assume that blockchain node G responds to the previous transaction published by anchor point A. Blockchain node G is generally a blockchain node closest to anchor point A. Certainly, implementations are not limited in the present specification.

In some embodiments, assuming that smart contract S uses the data structure shown in FIG. 2, data of the blockchain balance can be recorded in the storage structure of smart contract S. After being created and published to the blockchain network, smart contract S reaches a consensus between blockchain nodes in the blockchain network, and is recorded on each blockchain node. For example, smart contract S is also recorded on blockchain node G described above.

In some embodiments, many smart contracts can exist in a blockchain network for implementing corresponding events or purposes. Therefore, the previous transaction can include a contract address and port information, etc. of smart contract S. As such, blockchain node G can determine, based on the contract address, that the transaction needs to invoke smart contract S, and invoke, based on the port information, the contract code included in smart contract S so as to update metadata and further add a new field to the data.

Step 302: Blockchain node G verifies a data access permission of anchor point A on the blockchain balance.

In some embodiments, smart contract S can set a data access permission in a form similar to a whitelist or a blacklist to reduce unauthorized metadata modification and prevent a security risk caused by tampering with data such as a blockchain balance. For example, when the blockchain network belongs to a public blockchain, users with the data access permission can be a predetermined group of users. For another example, when the blockchain network belongs to a consortium blockchain, users with the data access permission can be consortium members. Therefore, when blockchain node G obtains the transaction published by anchor point A and determines that the transaction needs to update the metadata of smart contract S, blockchain node G can first determine whether anchor point A has the corresponding data access permission, and continue a subsequent step when anchor point A has the permission. Otherwise, blockchain node G can return failure information.

Notably, based on a feature of distributed data storage of a blockchain network, data published to the blockchain network needs to be recorded on all blockchain nodes, so that the data cannot be tampered with and is traceable. However, for data and its metadata that may be private to some extent such as the previous blockchain balance, privacy may not be ensured if the data is published to the blockchain network. However, if the data is not published to the blockchain network, the data may be unreliable and it is not conducive for each blockchain node to conveniently read and invoke related data or adjust the metadata. Therefore, in the present specification, the previous data and its metadata with a privacy need are recorded in a smart contract, and unauthorized access to the related data and its metadata by an unauthorized user can be limited through management of data access permissions. As such, the data and its metadata can be published to the blockchain network to ensure reliability and convenience brought by the blockchain network while sufficient privacy and security are ensured for the data and its metadata.

Step 303: When anchor point A has the data access permission, blockchain node G invokes the previous smart contract to update the metadata.

In some embodiments, anchor point A can specify a target user and a field attribute in the transaction to add a new field based on the field attribute for the target user. For example, when anchor point A needs to add a “type X blockchain balance” field for all users to record a status of each user's ownership over the type X blockchain asset, anchor point A can label “ALL” for the target user in the transaction, and the field attribute can include a field name, an exchange ratio of the type X blockchain asset to another asset, etc. For example, the field name can be “Balance-Type X”, and an exchange ratio of the type X blockchain asset to RMB can be “1:5”.

Step 304: Blockchain node G parses the metadata, and adds a related field to the data included in smart contract S.

In some embodiments, after the metadata included in smart contract S is adjusted based on the previous transaction published by anchor point A so that the adjusted metadata additionally describes Balance-Type X for the data corresponding to each user, in addition to Account ID, Age, Tel, Balance-Type A, Balance-Type B, and Total-RMB that are already described in Table 1.

Therefore, when the contract code in the code structure in smart contract S is run to parse the adjusted metadata in the storage structure, it can be determined that the previous “Balance-Type X” field is added to the parsed data structure when compared with the data structure of the data recorded in smart contract S. Therefore, the field can be added to data corresponding to each user, and the related data in Table 1 can be updated to the following data in Table 2.

TABLE 2

| Account | | | | Balance- | Balance- | Balance- | Total- |
|---|---|---|---|---|---|---|---|
| ID | Age | Tel | . . . | Type A | Type B | Type X | RMB |
| 0001 | 26 | 139 . . . | . . . | 2000 | 1500 | 0 | 5000 |
| 0002 | 25 | 186 . . . | . . . | 1000 | 6000 | 0 | 13000 |
| 0003 | 32 | 166 . . . | . . . | 20000 | 2100 | 0 | 24200 |
| . . . | . . . | . . . | . . . | . . . | . . . | . . . | . . . |

Therefore, after any user obtains the type X blockchain asset in a subsequent process, a status of the user's ownership over the type X blockchain asset can be directly recorded in the data of smart contract S without concerning a compatibility issue.

Step 305: Blockchain node G returns a processing result to anchor point A.

FIG. 4 is a schematic diagram illustrating deletion of an existing field, according to some example embodiments. As shown in FIG. 4, a process of deleting an existing field can include the following steps:

Step 401: Create a transaction.

In some embodiments, assuming that anchor point A terminated releasing a type X blockchain asset to a blockchain network, and correspondingly, published type X blockchain assets need to be cleared. In these embodiments, anchor point A needs to delete a corresponding field from the data included in the above-mentioned smart contract S to stop recording a status of a user's ownership over the type X blockchain asset. Therefore, anchor point A can create a field deletion transaction (which is equivalent to a field deletion request) and publish the transaction to the blockchain network. Assume that blockchain node G responds to the previous transaction published by anchor point A. Blockchain node G is generally a blockchain node closest to anchor point A. Certainly, implementations are not limited in the present specification.

In some embodiments, the previous transaction can include a contract address and port information, etc. of smart contract S. As such, blockchain node G can determine, based on the contract address, that the transaction needs to invoke smart contract S, and invoke, based on the port information, the contract code included in smart contract S so as to update metadata and further delete an existing field from the data.

Step 402: Blockchain node G verifies a data access permission of anchor point A on the blockchain balance.

In some embodiments, similar to step 302 above, the data access permission of blockchain node G can be verified. Details are omitted here for simplicity.

Step 403: When anchor point A has the data access permission, blockchain node G invokes the previous smart contract to update the metadata.

In some embodiments, anchor point A can specify a target object in the transaction. For example, the target object can be a field name “Balance-Type X”, and can be used to determine a corresponding field and update corresponding content in the metadata, for example, delete content associated with the “Balance-Type X” field.

Step 404: Blockchain node G parses the metadata, and deletes a related field from the data included in smart contract S.

In some embodiments, after the metadata included in smart contract S is adjusted based on the previous transaction published by anchor point A so that the adjusted metadata does not describe Balance-Type X for the data corresponding to each user, but describes only Account ID, Age, Tel, Balance-Type A, Balance-Type B, and Total-RMB that are already described in Table 2.

Therefore, when the contract code in the code structure in smart contract S is run to parse the adjusted metadata in the storage structure, it can be determined that the previous “Balance-Type X” field is deleted from the parsed data structure when compared with the data structure of the data recorded in smart contract S. Therefore, the field can be deleted from data corresponding to each user, and the related data in Table 2 can be updated to the data in Table 1.

Step 405: Blockchain node G returns a processing result to anchor point A.

In some embodiments, anchor point A may only need to delete the “Balance-Type X” field from data corresponding to certain users (one or more users). For example, if certain users do not have a permission to own the type X blockchain asset, anchor point A can initiate the previous transaction for the users, and blockchain node G can update, based on the transaction, the metadata included in smart contract S. As such, when the contract code included in smart contract S is run to parse subsequently updated metadata, data recorded after an update time point cannot be accessed. It is equivalent to the following: The “Balance-Type X” field is deleted from the data corresponding to the users, and therefore the data of the users cannot be accessed after the update time point. Data recorded before the update time point remains accessible as the corresponding metadata still exists in the blockchain ledger.

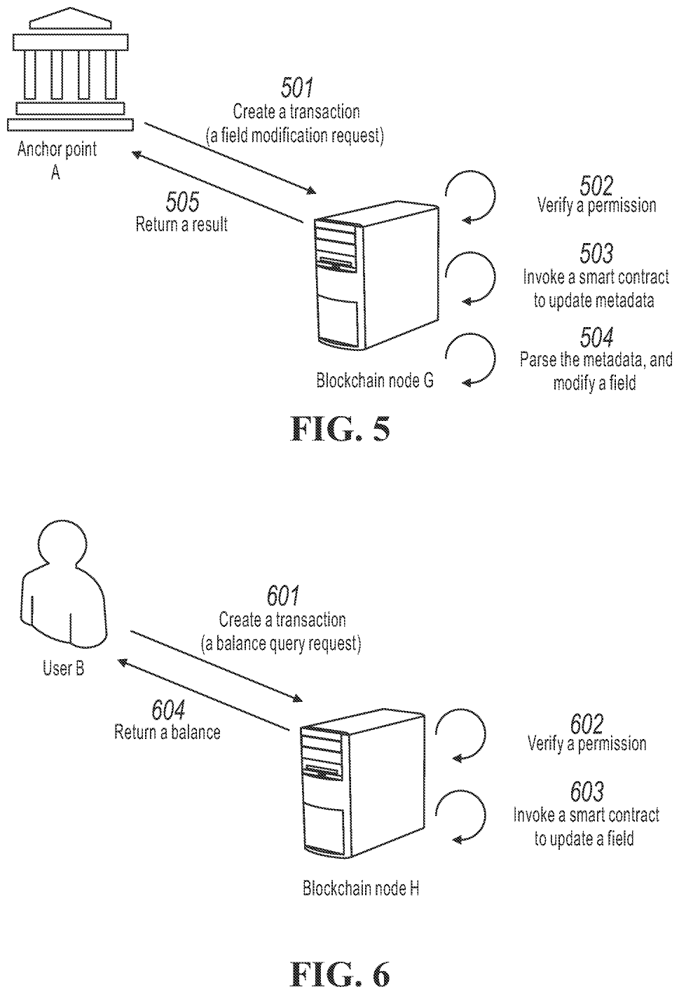

FIG. 5 is a schematic diagram illustrating modification of an existing field, according to some example embodiments. As shown in FIG. 5, a process of modifying an existing field can include the following steps:

Step 501: Create a transaction.

In some embodiments, in the data structure described in Table 1, the total amount of blockchain assets owned by a user is counted based on “RMB”. Assuming that anchor point A wants to modify the original “RMB” to “USD” for some reason, in other words, to count the total amount of the blockchain assets owned by the user in USD, anchor point A needs to modify the “Total-RMB” field described in Table 1 to a “Total-USD” field. Therefore, anchor point A can create a field modification transaction (which is equivalent to a field modification request) and publish the transaction to the blockchain network. Assume that blockchain node G responds to the previous transaction published by anchor point A. Blockchain node G is generally a blockchain node closest to anchor point A. Certainly, implementations are not limited in the present specification.

In some embodiments, the previous transaction can include a contract address and port information, etc. of smart contract S. As such, blockchain node G can determine, based on the contract address, that the transaction needs to invoke smart contract S, and invoke, based on the port information, the contract code included in smart contract S so as to update metadata and further modify an existing field in the data.

Step 502: Blockchain node G verifies a data access permission of anchor point A on the blockchain balance.

In some embodiments, similar to step 302 above, the data access permission of blockchain node G can be verified. Details are omitted here for simplicity.

Step 503: When anchor point A has the data access permission, blockchain node G invokes the previous smart contract to update the metadata.

In some embodiments, anchor point A can specify a target object and a field attribute in the transaction. For example, the target object can be a field name “Total-RMB”, and can be used to determine a corresponding field; and the field attribute can include a field name “Total-USD”, a method for calculating the total amount in USD (related to an exchange ratio of each type of blockchain asset to USD), etc., and can be used to update corresponding content in the metadata, for example, modify content related to the “Total-RMB” field to content related to the “Total-USD” field.

Step 504: Blockchain node G parses the metadata, and modifies a related field in the data included in smart contract S.

In some embodiments, after the metadata included in smart contract S is adjusted based on the previous transaction published by anchor point A so that the adjusted metadata additionally describes the “Total-USD” field that is modified from the “Total-RMB” field for the data corresponding to each user, in addition to Account ID, Age, Tel, Balance-Type A, and Balance-Type B that are already described in Table 1.

Therefore, when the contract code in the code structure in smart contract S is run to parse the adjusted metadata in the storage structure, it can be determined that the “Total-RMB” field is modified to the “Total-USD” field in the parsed data structure when compared with the data structure of the data recorded in smart contract S. Therefore, data corresponding to each user can be adjusted, and the related data in Table 1 can be updated to the following data in Table 3.

TABLE 3

| Account | | | | Balance- | Balance- | Total- |
|---|---|---|---|---|---|---|
| ID | Age | Tel | . . . | Type A | Type B | USD |
| 0001 | 26 | 139 . . . | . . . | 2000 | 1500 | 768.9114 |
| 0002 | 25 | 186 . . . | . . . | 1000 | 6000 | 1999.1696 |
| 0003 | 32 | 166 . . . | . . . | 20000 | 2100 | 3721.5311 |
| . . . | . . . | . . . | . . . | . . . | . . . | . . . |

Step 505: Blockchain node G returns a processing result to anchor point A.

In some embodiments, anchor point A may only need to modify the “Total-RMB” field in data corresponding to certain users (one or more users). For example, if certain users send a request for calculating blockchain assets owned by the users in USD to anchor point A, anchor point A can initiate the previous transaction for the users, and blockchain node G can update, based on the transaction, the metadata included in smart contract S. As such, when the contract code included in smart contract S is run to parse the updated metadata, the “Total-RMB” field in the data corresponding to the users is modified to the “Total-USD” field, and other users can still use RMB to calculate their own blockchain assets.

In the embodiments shown in FIG. 3 to FIG. 5, in one case, after receiving and responding to the transaction initiated by anchor point A, blockchain node G can simultaneously implement an update operation on the metadata included in smart contract S and a field update operation on the data included in smart contract S. For example, after completing the update operation on the metadata, blockchain node G can immediately parse the updated metadata by running the contract code included in smart contract S, so that a related field can be updated in the data included in smart contract S. In another case, blockchain node G can focus only on the update operation on the metadata, and implement the field update operation on the data at a different time.

The field modification case shown in FIG. 5 is used as an example. FIG. 6 is a schematic diagram illustrating querying a blockchain balance, according to some example embodiments. As shown in FIG. 6, a process of querying a blockchain balance can include the following steps:

Step 601: Create a transaction.

In some embodiments, assuming that user B needs to query the total amount of blockchain assets owned by user B in a blockchain network, user B can create a balance query transaction (which is equivalent to a balance query request), and publish the transaction to the blockchain network. Assume that blockchain node H responds to the previous transaction published by user B. Blockchain node H is generally a blockchain node closest to user B. Certainly, implementations are not limited in the present specification.

In some embodiments, the previous transaction can include a contract address and port information, etc. of smart contract S. As such, blockchain node H can determine, based on the contract address, that the transaction needs to invoke smart contract S, and invoke, based on the port information, the contract code included in smart contract S so as to implement operations such as a blockchain balance query.

Step 602: Blockchain node H verifies a data access permission of user B on the blockchain balance.

In some embodiments, similar to the embodiments shown in FIG. 3 to FIG. 5, verifying the data access permission of user B can realize convenience of data acquisition and ensure data security. Details are omitted here for simplicity.

Step 603: When user B has the data access permission, blockchain node H invokes the previous smart contract for a field update.

In some embodiments, user B can specify related information about a blockchain balance that needs to be queried in the transaction. For example, when user B wants to query a blockchain balance of user B, the related information can include an account ID and an asset type, etc. of user B. Blockchain node H can invoke the contract code in the code structure in smart contract S to parse the metadata in the storage structure in smart contract S by running the contract code, so as to determine a storage field corresponding to the previous related information specified in the transaction.

In some embodiments, assume that data recorded in smart contract S originally uses the structure described in Table 1, including personal information (such as an account ID, an age, and an address) of each user owning an account, a balance of a blockchain asset owned by each account, and the total amount of all blockchain balances counted in RMB, etc. In the present case, after the embodiment shown in FIG. 5, the data included in smart contract S is still temporarily recorded in the structure described in Table 1. However, because the metadata included in smart contract S is updated in the embodiment shown in FIG. 5, after the updated metadata is parsed based on the contract code included in smart contract S, a determined data structure is different from the data structure used by the data included in smart contract S, and therefore, a structure update needs to be implemented based on the metadata for the related data included in smart contract S.

TABLE 4

| Account | | | | Balance- | Balance- | Total- | Total- |
|---|---|---|---|---|---|---|---|
| ID | Age | Tel | . . . | Type A | Type B | RMB | USD |
| 0001 | 26 | 139 . . . | . . . | 2000 | 1500 | 5000 | / |
| 0002 | 25 | 186 . . . | . . . | 1000 | 6000 | / | 1999.1696 |
| 0003 | 32 | 166 . . . | . . . | 20000 | 2100 | 24200 | / |
| . . . | . . . | . . . | . . . | . . . | . . . | . . . | / |

In some embodiments, assuming that the account ID of user B is 0002, blockchain node H can add the “Total-USD” field to user information for the “Account ID=0002”, and modify data “13000” originally corresponding to the “Total-RMB” field to “1999.1696” in the “Total-USD” field. Such modification indicates that the total amount of blockchain assets owned by user B is equal to USD1999.1696. Because only the data of user B is involved, for user B, it is equivalent to modifying the “Total-RMB” field to the “Total-USD” field while other users still use the “Total-RMB” field until related data is involved. Such practice can greatly reduce workload, especially when only a few users are involved.

Step 604: Blockchain node H returns a queried balance to user B.

In some embodiments, as the “Total-RMB” field is modified to the “Total-USD” field in the data corresponding to user B, the balance returned by blockchain node H is “USD1999.1696” instead of “RMB13000” that is returned before the field is modified.

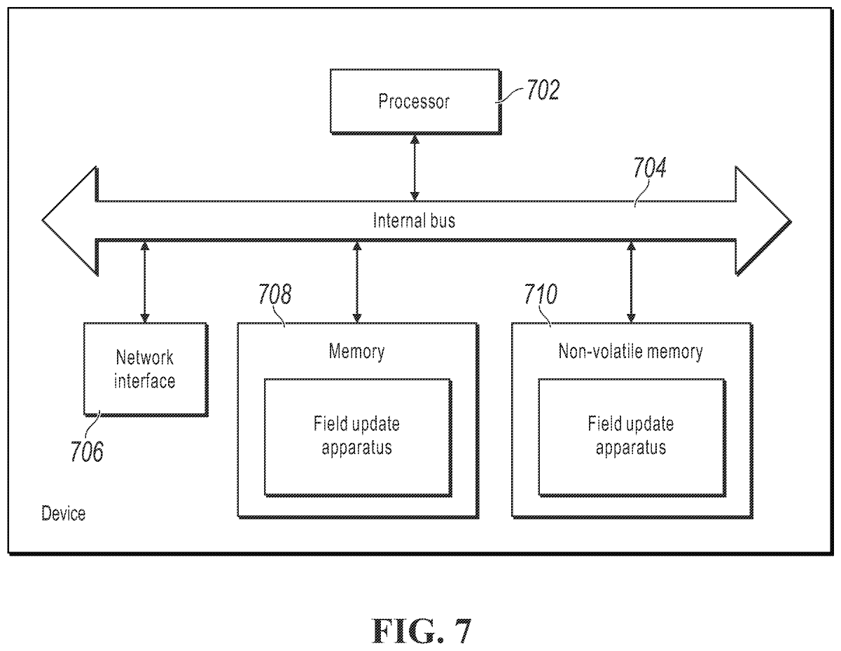

FIG. 7 is a schematic structural diagram illustrating a device, according to some example embodiments.

Referring to FIG. 7, in terms of hardware, the device includes a processor 702, an internal bus 704, a network interface 706, a memory 708, and a non-volatile memory 710, and certainly can further include hardware needed by other services.

The processor 702 reads a corresponding computer program from the non-volatile memory 710 to the memory 708 for running, and a field update apparatus is logically formed. Certainly, in addition to a software implementation, one or more embodiments of the present specification do not exclude another implementation, for example, a logic device or a combination of hardware and software. That is, an execution body of the following processing procedure is not limited to each logical unit, and can also be hardware or a logic device.

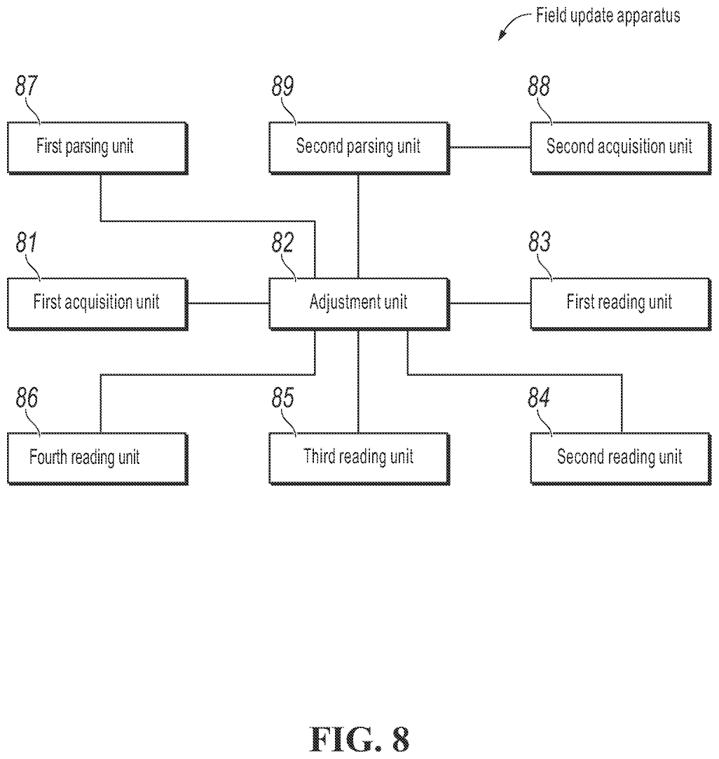

Referring FIG. 8, in a software implementation, the field update apparatus can include the following: a first acquisition unit 81, configured to enable a blockchain node in a blockchain network to obtain a field update request for a smart contract, where the field update request is used to implement a field update on data in a data set included in the smart contract; and an adjustment unit 82, configured to enable the blockchain node to adjust, based on the field update request, metadata included in the smart contract, such that a field update is achieved on the data in the data set after parsing the adjusted metadata by using code included in the smart contract.

Optionally, the field update apparatus further includes the following: a first reading unit 83, configured to enable the blockchain node to read input parameters included in the field update request, where the input parameters include a target object; where the adjusted metadata is used to determine a field corresponding to the target object from the data set so as to delete the field corresponding to the target object.

Optionally, the field update apparatus further includes the following: a second reading unit 84, configured to enable the blockchain node to read input parameters included in the field update request, where the input parameters include a target object and a field attribute; where the adjusted metadata is used to determine a field corresponding to the target object from the data set so as to update an attribute of the determined field to the field attribute.

Optionally, the field update apparatus further includes the following: a third reading unit 85, configured to enable the blockchain node to read input parameters included in the field update request, where the input parameters include a field attribute; where the adjusted metadata is used to add a field to the data set, and set an attribute of the added field to the field attribute.

Optionally, the data set includes data of at least one user; and the apparatus further includes the following: a fourth reading unit 86, configured to enable the blockchain node to read input parameters included in the field update request, where the input parameters include information about a target user; where the adjusted metadata is used to determine data corresponding to the target user from the data set so as to update a field of the data corresponding to the target user.

Optionally, the field update apparatus further includes the following: a first parsing unit 87, configured to enable the blockchain node to parse the adjusted metadata by running the code included in the smart contract so as to implement a field update on global data of the data set based on a parsing result.

Optionally, the field update apparatus further includes the following: a second acquisition unit 88, configured to enable the blockchain node to obtain a data read and write request for the smart contract, where the data read and write request is used to implement a data read and write operation on a target object in the data set; and a second parsing unit 89, configured to enable the blockchain node to parse the adjusted metadata by running the code included in the smart contract, where a parsing result is used to determine target data corresponding to the target object in the data set and implement a field update on the target data so as to implement the data read and write operation on the target data after the field update.

The system, apparatus, module, or unit illustrated in the previous embodiments can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, a computer includes one or more processors (CPUs), an input/output interface, a network interface, and a memory.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. The information can be a computer-readable instruction, a data structure, a program module, or other data. Examples of a computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD) or another optical storage, a cassette tape, a magnetic disk storage, a quantum memory, a storage medium based on grapheme, another magnetic storage device, or any other non-transmission medium. The computer storage medium can be used to store information that can be accessed by a computing device. Based on the description in the present specification, the computer-readable medium does not include transitory computer-readable media (transitory media), for example, a modulated data signal and carrier.

It is worthwhile to further note that, the terms “include”, “comprise”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a ... ” does not preclude the existence of additional identical elements in the process, method, product or device that includes the element.

Specific embodiments of the present specification are described above. Other embodiments fall within the scope of the appended claims. In some situations, the actions or steps described in the claims can be implemented in an order different from the order in the embodiments and the desired results can still be achieved. In addition, the process depicted in the accompanying drawings does not necessarily need a particular execution order to achieve the desired results. In some implementations, multi-tasking and concurrent processing are feasible or can be advantageous.

Terms used in one or more embodiments of the present specification are merely used to describe specific embodiments, and are not intended to limit the one or more embodiments of the present specification. The terms “a” and “the” of singular forms used in one or more embodiments of the present specification and the appended claims are also intended to include plural forms, unless otherwise specified in the context clearly. It should also be understood that, the term “and/or” used here indicates and includes any or all possible combinations of one or more associated listed items.

It should be understood that although terms “first”, “second”, “third”, etc. can be used in one or more embodiments of the present specification to describe various types of information, the information is not limited to these terms. These terms are only used to differentiate between information of the same type. For example, without departing from the scope of one or more embodiments of the present specification, first information can also be referred to as second information, and similarly, the second information can be referred to as the first information. Depending on the context, for example, the word “if” used here can be explained as “while”, “when”, or “in response to determining”.

The previous descriptions are only example embodiments of one or more embodiments of the present specification, but are not intended to limit the one or more embodiments of the present specification. Any modification, equivalent replacement, improvement, etc. made without departing from the spirit and principle of the one or more embodiments of the present specification shall fall within the protection scope of the one or more embodiments of the present specification.

What is claimed is:

1. A computer-implemented method for updating fields in a blockchain smart contract comprising:
obtaining, by a blockchain node in a blockchain network, a field update request for a smart contract, wherein the field update request is used to implement a field update on data in a data set in the smart contract;
adjusting, by the blockchain node based on the field update request and as adjusted metadata, metadata in the smart contract; and
parsing, using code in the smart contract, the adjusted metadata to update a field associated with the field update request.

2. The computer-implemented method according to claim 1, further comprising:
reading, by the blockchain node, input parameters of the field update request, wherein the input parameters comprise a target object, wherein the adjusted metadata is used to determine a field corresponding to the target object from the data set and to delete the field corresponding to the target object.

3. The computer-implemented method according to claim 1, further comprising:
reading, by the blockchain node, input parameters of the field update request, wherein the input parameters comprise a target object and a field attribute, wherein the adjusted metadata is used to determine, as a determined field, a field corresponding to the target object from the data set and to update an attribute of the determined field to the field attribute.

4. The computer-implemented method according to claim 1, further comprising:
reading, by the blockchain node, input parameters of the field update request, wherein the input parameters comprise a field attribute, and wherein the adjusted metadata is used to add, as an added field, a field to the data set, and set an attribute of the added field to the field attribute.

5. The computer-implemented method according to claim 1, wherein:
the data set comprises data of at least one user; and
further comprising:
reading, by the blockchain node, input parameters of the field update request, wherein the input parameters comprise information about a target user, and wherein the adjusted metadata is used to determine data corresponding to the target user from the data set so as to update a field of the data corresponding to the target user.

6. The computer-implemented method according to claim 1, further comprising:
parsing, by the blockchain node, the adjusted metadata by running the code in the smart contract to implement a field update on global data of the data set based on a parsing result.

7. The computer-implemented method according to claim 1, further comprising:
obtaining, by the blockchain node, a data read/write request for the smart contract, wherein the data read/write request is used to implement a data read/write operation on a target object in the data set; and
parsing, by the blockchain node, the adjusted metadata by running the code in the smart contract, wherein a parsing result is used to determine target data corresponding to the target object in the data set and implement a field update on the target data so as to implement the data read/write operation on the target data after the field update.

8. A non-transitory, computer-readable medium storing one or more instructions executable by a computer system to perform operations comprising:
obtaining, by a blockchain node in a blockchain network, a field update request for a smart contract, wherein the field update request is used to implement a field update on data in a data set in the smart contract;
adjusting, by the blockchain node based on the field update request and as adjusted metadata, metadata in the smart contract; and
parsing, using code in the smart contract, the adjusted metadata to update a field associated with the field update request.

9. The non-transitory, computer-readable medium of claim 8, further comprising:
reading, by the blockchain node, input parameters of the field update request, wherein the input parameters comprise a target object, wherein the adjusted metadata is used to determine a field corresponding to the target object from the data set and to delete the field corresponding to the target object.

10. The non-transitory, computer-readable medium of claim 8, further comprising:
reading, by the blockchain node, input parameters of the field update request, wherein the input parameters comprise a target object and a field attribute, wherein the adjusted metadata is used to determine, as a determined field, a field corresponding to the target object from the data set and to update an attribute of the determined field to the field attribute.

11. The non-transitory, computer-readable medium of claim 8, further comprising:
reading, by the blockchain node, input parameters of the field update request, wherein the input parameters comprise a field attribute, and wherein the adjusted metadata is used to add, as an added field, a field to the data set, and set an attribute of the added field to the field attribute.

12. The non-transitory, computer-readable medium of claim 8, wherein:
the data set comprises data of at least one user; and
the operations further comprise:
reading, by the blockchain node, input parameters of the field update request, wherein the input parameters comprise information about a target user, and wherein the adjusted metadata is used to determine data corresponding to the target user from the data set so as to update a field of the data corresponding to the target user.

13. The non-transitory, computer-readable medium of claim 8, further comprising:
parsing, by the blockchain node, the adjusted metadata by running the code in the smart contract to implement a field update on global data of the data set based on a parsing result.

14. The non-transitory, computer-readable medium of claim 8, further comprising:
obtaining, by the blockchain node, a data read/write request for the smart contract, wherein the data read/write request is used to implement a data read/write operation on a target object in the data set; and
parsing, by the blockchain node, the adjusted metadata by running the code in the smart contract, wherein a parsing result is used to determine target data corresponding to the target object in the data set and implement a field update on the target data so as to implement the data read/write operation on the target data after the field update.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining, by a blockchain node in a blockchain network, a field update request for a smart contract, wherein the field update request is used to implement a field update on data in a data set in the smart contract;
adjusting, by the blockchain node based on the field update request and as adjusted metadata, metadata in the smart contract; and
parsing, using code in the smart contract, the adjusted metadata to update a field associated with the field update request.

16. The computer-implemented system of claim 15, further comprising:
reading, by the blockchain node, input parameters of the field update request, wherein the input parameters comprise a target object, wherein the adjusted metadata is used to determine a field corresponding to the target object from the data set and to delete the field corresponding to the target object.

17. The computer-implemented system of claim 15, further comprising:
reading, by the blockchain node, input parameters of the field update request, wherein the input parameters comprise a target object and a field attribute, wherein the adjusted metadata is used to determine, as a determined field, a field corresponding to the target object from the data set and to update an attribute of the determined field to the field attribute.

18. The computer-implemented system of claim 15, further comprising:
reading, by the blockchain node, input parameters of the field update request, wherein the input parameters comprise a field attribute, and wherein the adjusted metadata is used to add, as an added field, a field to the data set, and set an attribute of the added field to the field attribute.

19. The computer-implemented system of claim 15, wherein:
the data set comprises data of at least one user; and
the one or more operations further comprise:
reading, by the blockchain node, input parameters of the field update request, wherein the input parameters comprise information about a target user, and wherein the adjusted metadata is used to determine data corresponding to the target user from the data set so as to update a field of the data corresponding to the target user.

20. The computer-implemented system of claim 15, further comprising:
parsing, by the blockchain node, the adjusted metadata by running the code in the smart contract to implement a field update on global data of the data set based on a parsing result.
